(19) United States
(12) Patent Application Publication
(10) Pub. No.: US 2003/0198041 A1
(43) Pub. Date: Oct. 23, 2003

(54) Glow in the dark candle

(76) Inventor: Jordi Dalmau, Coral Gables, FL (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 10/127,194

(22) Filed: Apr. 22, 2002

(51) Int. Cl. F21V 9/16

(52) U.S. Cl. 362/84

(57) ABSTRACT

A luminescent compound forms a layer in a gel candle whereby the luminescent layer glows in the dark when the candle is not lighted. A method for making a candle having a luminescent layer comprises the steps of dispersing a luminescent powder into a heated gel, allowing the gel to solidify, pouring a second, hydrocarbon heated gel over the first, inserting a wick, and allowing the article to cool.

### TECHNICAL FIELD

This invention relates to a transparent gel candle that incorporates a glow-in-the-dark composition and a method for making the same. Whether lighted or not, the candle is esthetically pleasing to the eye while satisfying the utilitarian functions of providing light or being able to be seen in a dark environment while not lighted.

### BACKGROUND OF THE INVENTION

U.S. Pat. No. 5,879,694 to Morrison, et al., describes and claims a candle whose primary burning substance is a gel in which is embedded a wick. The gel may be clear or colored, and may have a fragrant substance mixed into the gel to provide a pleasing aroma. The composition described and claimed by Morrison is the basis for this invention, and the teachings of that patent are fully incorporated herein. Morrison teaches a candle made from a gel composition that may also include additives such as a colorant, a fragrance, an anti-oxidizing agent, a stabilizer, or some other functional agent. In appearance, such a gel candle is translucent or transparent when contained within a transparent container, and may also exhibit other visual characteristics, such as large or small interior bubbles, a colored tint or hue, and a variety of visually pleasing effects caused by a flickering flame.

The present invention provides another pleasing effect, which is to have a portion of the gel candle exhibit a luminescence that may be described as glow-in-the-dark. When the luminescent composition is incorporated into a gel candle, the candle will glow in a dark environment, even when it is not lit, providing both a pleasing esthetic appearance and a means for locating it for lighting in an otherwise dark room.

### SUMMARY OF THE INVENTION

A commercial luminescent composition may be mixed with the gel, poured into a transparent, heat-resistant container, and used as a layer of a gel candle. An upper layer of gel is then applied and a wick is inserted to form a gel candle having luminescent properties.

### BRIEF DESCRIPTION OF THE DRAWINGS

FIG. 1 depicts a completed gel candle having a luminescent composition at the base of the container.

FIG. 2 depicts the luminescent layer within a container prior to the introduction of an upper layer of gel.

FIG. 3 depicts another embodiment of the luminescent candle in which the luminescent layer is located above a lower layer.

### DESCRIPTION OF THE PREFERRED EMBODIMENTS

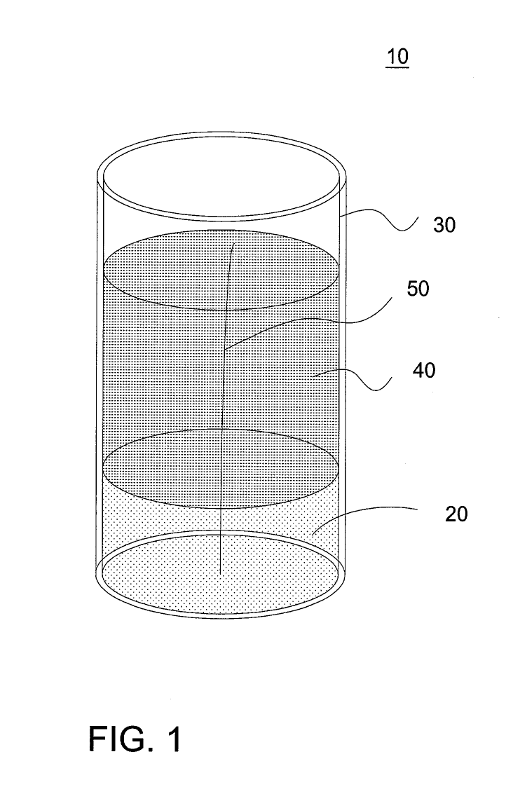

In FIG. 1, a luminescent gel candle 10 is shown. A luminescent composition, which includes a fire-retardant mixture of a zinc sulfide powder and a gel, occupies a bottom layer 20 in a container 30, while an upper layer of gel 40, as disclosed by Morrison, provides the fuel for burning. While the gel used in the luminescent composition and the upper gel layer may be the same substance, the invention does not require that they be the same substance. The luminescent composition may be made using a commercial zinc sulfide powder such as is sold by United Minerals under the tradename “Luminova.”® The powder is dispersed into a gel which has been preheated to a temperature of between 220° and 260° F. The proportion of the powder, which is heavy and dense, to the gel is about 3%-10% by weight, and the resultant mixture must be maintained between 220° and 260° F. while being agitated for a period of 45-60 minutes while the powder is dispersed throughout the composition. When mixing has been completed, the still-heated luminescent composition may be poured into the candle container and allowed to cool to ambient temperature. When the composition has cooled for a period of about 4-5 hours, it will be sufficiently solidified that an upper layer of a hydrocarbon gel may be poured on top of it. The upper gel layer should be heated to a temperature of 240° to 260° F. prior to pouring. The temperature within the container is then allowed to cool to between 180° and 190° F., and a wick 50 may be inserted. Insertion of the wick, which may be precut to the size of the container, is done with a needle that penetrates through the upper gel layer to the luminescent layer, pulling the wick with it. The needle is then extracted, leaving the wick embedded in the luminescent layer and surrounded throughout most of its length by the upper gel layer.

As the candle burns, the hydrocarbon gel will become used up, and the wick will become correspondingly shortened until it reaches the luminescent layer. Because the luminescent layer is fire-retardant, the candle flame will lack fuel and become extinguished upon the wick's reaching that level. If the candle is located in an otherwise dark room when the flame becomes extinguished, the luminescent layer will continue to glow, and a pleasing visual effect will remain.

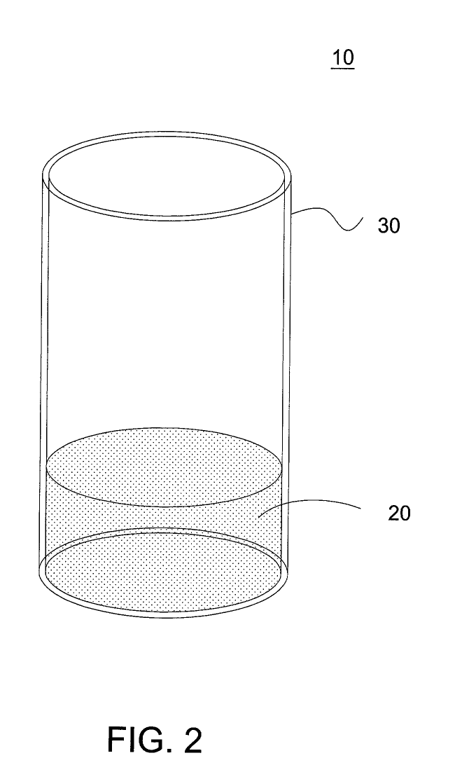

In FIG. 2, the container 30 containing the luminescent layer 20 is shown. While the container may be of any shape suitable to hold a liquid or gel, it should be able to withstand the heat of the composition when poured, and of the candle flame, without cracking, and preferably should be transparent. About 4 to 5 hours after being poured, the luminescent composition will have solidified and will be at room temperature. The upper gel layer may then be poured.

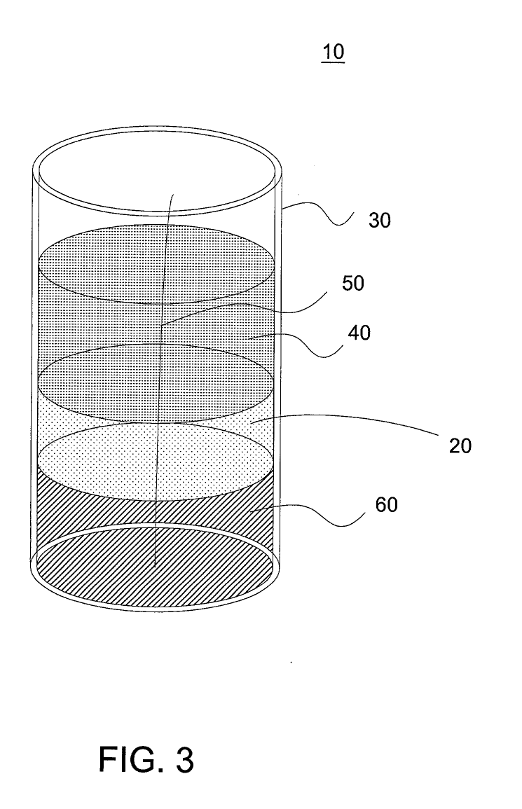

FIG. 3 shows an embodiment in which the luminescent layer 20 is located in an intermediate layer above the lowest layer 60 of the candle. The lowest layer may be a hydrocarbon gel or not, although the topmost layer 40 must be a hydrocarbon gel in order to support burning. Because the luminescent layer is fire-retardant, this embodiment reduces the overall length of time that the candle will burn before the wick reaches that layer. Nevertheless, there may be applications or desired visual effects in which this embodiment is used.

The invention has been described herein with reference to certain embodiments. However, obvious variants thereon will be evident to those skilled in the art, and the invention is not to be considered as limited to only the disclosed embodiments.

What is claimed is:

1. A luminescent gel candle comprising: a container, a luminescent layer within said container, a hydrocarbon gel layer within said container, and a wick.

2. A luminescent candle as claimed in claim 1 wherein said luminescent layer is the lowest layer in said container.

3. A luminescent candle as claimed in claim 2 wherein a lower end of said wick is embedded in said luminescent layer and an upper end of said wick extends upward to terminate above the uppermost layer.

4. A luminescent candle as claimed in claim 1, in which said luminescent layer further comprises a mixture of a luminescent powder and a gel.

5. A luminescent candle as claimed in claim 4 wherein said luminescent powder comprises zinc sulfate.

6. A luminescent candle as claimed in claim 5 wherein said luminescent powder comprises about 3 to 10 percent of the weight of said luminescent composition.

7. A luminescent candle as claimed in claim 1 wherein said luminescent layer is a fire retardant.

8. A method of making a luminescent gel candle comprising the steps of:
heating a first gel;
dispersing a luminescent powder into said heated first gel;
mixing said heated first gel and said luminescent powder to form a more or less homogenous composition;
pouring said composition into a container;
allowing said composition to solidify;
pouring a second heated hydrocarbon gel into said container to form a layer above said composition;
inserting a wick.

9. A method of making a luminescent gel candle as claimed in claim 8, further comprising heating said first gel to a temperature of approximately 220-260 degrees F.

10. A method of making a luminescent gel candle as claimed in claim 9, further comprising maintaining the temperature of said composition at approximately 220-260 degrees F. while continuously mixing said composition.

11. A method of making a luminescent gel candle as claimed in claim 10, in which the proportion of said luminescent powder comprises approximately 3-10 percent of said composition by weight.

12. A method of making a luminescent gel candle as claimed in claim 11 wherein said second combustible gel is heated to a temperature of approximately 240-260 degrees F. before being poured into said container.

13. A method of making a luminescent gel candle comprising the steps of:
heating a first gel;
dispersing a luminescent powder into said heated first gel;
mixing said heated first gel and said luminescent powder to form a more or less homogenous composition;
heating a combustible second gel;
pouring said second gel into a container;
allowing said second gel to solidify;
pouring said composition into said container to form a layer above said second gel;
inserting a wick.

14. A method of making a luminescent candle as claimed in claim 13, further comprising the step of maintaining said composition at a temperature of approximately 220-260 degrees F. while mixing said composition.

15. A method of making a luminescent candle as claimed in claim 14, further comprising the step of heating said second gel to a temperature of approximately 240-260 degrees F. before pouring said second gel into said container.

16. A method of making a luminescent candle as claimed in claim 15, further comprising cooling said second gel and said composition to a temperature of approximately 180-190 degrees F. in said container prior to inserting said wick.

17. A method of making a luminescent candle as claimed in claim 13, further comprising pouring a gel to form an upper gel layer above said composition layer.

18. A method of making a luminescent candle as claimed in claim 17, in which said upper gel layer comprises a combustible gel.
